(19) United States
(12) Patent Application Publication
(10) Pub. No.: US 2021/0035109 A1
(43) Pub. Date: Feb. 4, 2021

(54) METHODS AND SYSTEMS FOR ENROLLMENT AND USE OF BIOMETRIC PAYMENT CARD

(71) Applicant: MASTERCARD INTERNATIONAL INCORPORATED, Purchase, NY (US)

(72) Inventors: Bernard Wong, Markham (CA); Rajat Maheshwari, Singapore (SG)

(21) Appl. No.: 16/527,566

(22) Filed: Jul. 31, 2019

(51) Int. Cl. G06Q 20/40; G06K 9/00

(52) U.S. Cl. CPC G06Q 20/40145; G06K 9/00087; G06Q 20/409

(57) ABSTRACT

Methods and apparatus for enrolling a biometric payment card. In an embodiment, a biometric payment card processor receives fingerprint image data of a cardholder's finger during an initial purchase transaction, extracts digital information from the fingerprint image data and generates current fingerprint template data. The biometric payment card processor then compares the current fingerprint template data to data stored in a memory, determines that the current fingerprint template data did not match any data stored in the memory, transmits cardholder identification data and an authentication failure message to a payment card reader device, receives enrollment instructions from the payment card reader device, and then stores, in response to the instructions, the current fingerprint template data as enrollment fingerprint template data in the memory.

### FIELD OF THE INVENTION

Embodiments generally relate to methods, apparatus and systems for securely and conveniently enrolling consumer biometric data into a biometric payment card, and methods concerning subsequent use of the biometric payment card. More specifically, in some embodiments a user is provided with a biometric payment card and then enrolls his or her fingerprints during a first purchase transaction directly into the biometric payment card for use in future purchase transactions. Fingerprint template data obtained from the consumer during one or more subsequent purchase transactions with the biometric payment card may then be used to refine, modify or replace the initial biometric enrollment data.

### BACKGROUND

Millions of consumer transactions occur daily using payment cards, such as credit cards, debit cards, prepaid cards, and the like financial products. Consumers or cardholders may engage in transactions in a variety of different environments, such as in a retail store, over the Internet (or online), at automatic-teller machines (ATMs), and/or via a telephone call to order merchandise via an interaction between the cardholder and a customer service representative. Fraudulent or illegal transactions can occur in each of these cases.

A typical retail store purchase transaction involves a customer bringing one or more items to a checkout counter or cash register station, where a cashier or clerk scans the items and a purchase amount is tabulated. After all of the merchandise or items are scanned, the customer pulls out his or her plastic payment card and then either swipes the payment card through a card reader (if it is a magnetic stripe card) or inserts it into, or taps it on, a chip card reader (if it is a smart payment card or a chip card). The card reader reads cardholder credential data from the payment card and then transmits that data to the cash register, which then forwards the cardholder credential data along with purchase transaction data to an acquirer financial institution (FI), which then transmits it to a payment network. Next, the payment network identifies the issuer FI which issued the customer's payment card account, and then transmits the cardholder credential data and the purchase transaction data to that issuer FI for authorization processing. If all is in order (i.e., the issuer FI verifies the cardholder credential data and confirms that the payment card account has an adequate credit line available to cover the cost of the purchase), then the issuer FI authorizes the purchase transaction and transmits an authorization response to the payment network. The payment network forwards the authorization response to the acquirer FI, which then transmits an authorization message to the merchant's cash register and/or card reader for display to the cashier and the cardholder. In some cases, the customer is then prompted to utilize a special stylus or pen to sign an electronic signature pad associated with the card reader, but in other cases (for example, when the purchase transaction amount is below a predetermined threshold amount) the customer is not required to provide his or her signature. The customer is then typically provided with a paper receipt for the purchase transaction (which may include the merchant store name, a list of the items purchased and their cost, the total purchase amount, and an indication identifying the type of payment card account used by the customer) and then leaves the retail store.

In-store payment card purchase transaction processes may vary somewhat from the above example, and may also vary depending on the equipment being used by a particular merchant and/or retail store (for example, some card readers may be configured for the consumer to tap his or her near-field communication (NFC) payment card on a designated area instead of inserting or swiping the payment card through the card reader). Regardless of how cardholder data is obtained from a payment card, most cashiers and/or store clerks do not bother to verify or check the cardholder's signature. Thus, a thief may be able to use a stolen payment card to make fraudulent purchases until the actual cardholder realizes that his or her payment card has been lost or stolen, and then contacts the issuer FI to cancel or suspend that payment card account.

The risk of fraudulent activity (and loss of money) has increased with the increased use of payment card accounts, and thus major payment card transaction processing companies such as Mastercard International Incorporated, Visa Inc., and the American Express Company have designed and implemented various types of anti-fraud mechanisms and/or features. For example, many payment cards have been issued that include security features such as holograms, a photograph of the cardholder appearing on the rear side of the payment card, and/or a card verification code (CVC). In addition, payment card credential data processing features have been implemented that require the cardholder to use passwords and/or personal identification numbers (PINs). The payment card transaction processing companies have also implemented various types of payment card account fraud monitoring and notification processes in order to prevent and/or curtail fraudulent activities.

In order to further reduce the risk of fraud in card-present transactions, Mastercard International Incorporated introduced the Mastercard® Biometric Card, which provides a simple and secure way for cardholders to authenticate their identity for in-store purchases with a fingerprint, as an alternative to utilizing a PIN, a password or a signature. Since biometric characteristics are difficult to duplicate, they are ideal for use to protect against fraudulent activities. The Mastercard® Biometric Card includes fingerprint template data that is stored on the biometric payment card itself, and during purchase transaction processing (which includes user authentication of the cardholder) the fingerprint template data never leaves the biometric payment card. Instead, the cardholder places his or her finger (such as a thumb) on a fingerprint sensor built into the biometric payment card during a payment transaction. Fingerprint data is then obtained and compared to the stored fingerprint template data, and an authentication message transmitted to a merchant's reader device. The fingerprint template data on the biometric payment card data is not shared with the merchant, and therefore is not transmitted to a remote server for authentication purposes. Such operation protects the cardholder's personal identification data while also improving security of the purchase transaction.

Biometric payment card transactions using the Mastercard Biometric Card are promptly conducted because cardholders do not need to remember and then enter a PIN during the checkout process. In addition, biometric card transactions do not require any hardware or software changes to current EMV®-enabled payment terminals, and thus there is no need for the merchant to make any hardware or software updates (the acronym EMV® stands for “Europay, Mastercard, Visa,” and denotes a global standard for cards equipped with computer chips and the technology used to authenticate chip-card transactions). Thus, cardholders enjoy an easy and secure checkout experience, while merchants can have enhanced certainty of genuine cardholder identity, which may result in an increase in revenue (from a reduction in false declines and/or a reduction in forgotten PIN transactions).

A challenge encountered when issuing biometric payment cards to consumers concerns enrollment of a consumer's biometric data, such as fingerprint template data, into a memory of the biometric payment card. In one enrollment method, the issuer FI provides a biometric payment card to the consumer via regular mail or via courier with instructions directing the consumer to go to a bank, a company office, a co-branded location or to a third-party entity affiliated with the issuer FI to enroll by providing biometric data into a tablet computer. In this case, the affiliated entity or issuer bank provides a tablet computer that includes an integrated scanner to perform, for example, fingerprint capture and to securely transfer at least two digital images immediately to the biometric payment card. Such an enrollment procedure can be conducted in about five (5) minutes or less at the designated location, is very secure, and includes obtaining an accurate and robust biometric enrollment image. This process also includes the advantage of having a customer service representative present to guide the consumer through the biometric data acquisition process and to answer any questions. However, such an enrollment process is expensive for the issuer FI and may also be inconvenient and/or somewhat time-consuming for some customers because of the requirement to take a trip to a designated location (such as a bank) to enroll.

Another enrollment procedure involves the issuer financial institution (FI) providing a disposable, light weight plastic sleeve along with the biometric payment card to the consumer (which is typically mailed in a package to the consumer's residence address). When the consumer receives the package, he or she removes the biometric payment card and plastic sleeve, which is sized to encase the biometric payment card, and follows instructions included in the package to enroll. The plastic sleeve includes electronic circuitry and a battery that enables the cardholder to enroll directly into the biometric card by using the biometric card's embedded biometric sensor (i.e., a fingerprint sensor), wherein the enrollment process typically takes a few minutes without issuer FI supervision. Although this biometric card enrollment procedure enables a consumer to enroll his or her biometric data (fingerprint data or fingerprint template data) while at home and is thus convenient, if he or she misunderstands the directions or instructions and/or an error occurs then the consumer may decide to abandon the process and thus fail to enroll. In addition, the biometric enrollment image (for example, the fingerprint image data) is limited by the size of the small sensor typically provided on the face of a biometric payment card, and thus may be inaccurate and/or difficult to match.

Accordingly, it would be advantageous to develop an easy and secure process for enrolling customer biometric data, such as fingerprint template data, into a newly issued biometric payment card that overcomes the drawbacks of the above described methods and leads to increased acceptance by consumers of biometric payment cards.

### BRIEF DESCRIPTION OF THE DRAWINGS

Features and advantages of some embodiments, and the manner in which the same are accomplished, will become more readily apparent with reference to the following detailed description taken in conjunction with the accompanying drawings, which illustrate exemplary embodiments, wherein:

FIG. 1A is a diagram illustrating the components of a biometric payment card according to some embodiments of the disclosure;

FIG. 1B is a block diagram of the components of a biometric payment card in accordance with some embodiments of the disclosure;

FIG. 2 is a block diagram of a purchase transaction system to illustrate a fingerprint enrollment process in accordance with some embodiments of the disclosure;

FIG. 3 is a graphical flow diagram illustrating enrollment of a digital image of a cardholder's fingerprint according to some embodiments of the disclosure; and

FIGS. 4A, 4B, 4C and 4D illustrate examples of cardholder fingerprint matching behaviors in accordance with some embodiments of the disclosure;

FIG. 5 is a flowchart of a biometric payment card enrollment process in accordance with some embodiments of the disclosure; and

FIG. 6 is a flowchart of a biometric payment card updating process in accordance with some embodiments of the disclosure.

### DETAILED DESCRIPTION

Reference will now be made in detail to various novel embodiments, examples of which are illustrated in the accompanying drawings. The drawings and descriptions thereof are not intended to limit the invention to any particular embodiment(s). On the contrary, the descriptions provided herein are intended to cover alternatives, modifications, and equivalents thereof. In the following description, numerous specific details are set forth in order to provide a thorough understanding of the various embodiments, but some or all of these embodiments may be practiced without some or all of the specific details. In other instances, well-known process operations have not been described in detail in order not to unnecessarily obscure novel aspects.

A number of terms will be used herein. The use of such terms is not intended to be limiting, but rather are used for convenience and ease of exposition. For example, as used herein, the term “consumer” may be used interchangeably with the term “cardholder” or “user” and such terms are used herein to refer to a consumer, person, individual, business or other entity that owns (or is authorized to use) a financial account such as a payment card account (for example, a credit card account). In addition, the term “biometric payment card account” may include or be associated with a credit card account, a debit card account, and/or a deposit account or other type of financial account that an account holder may access. The term “payment card account number” or “biometric payment card account number” includes a number that identifies a payment card system account or a number carried by a payment card, and/or a number that is used to route a transaction in a payment network that handles debit card and/or credit card transactions and the like. Moreover, as used herein the terms “payment network,” “payment card system” and/or “payment system” refer to a system and/or network for processing and/or handling purchase transactions and related financial transactions, which may be operated by a payment card system operator such as Mastercard International Incorporated (the assignee of the present application), or a similar system. In some embodiments, the term “payment card system” may be limited to systems in which member financial institutions (such as banks) issue payment card accounts to individuals, businesses and/or other entities or organizations.

As used herein, the term “issuer” and/or “issuer FI” is used to refer to the financial institution or entity (such as a bank) that issues a biometric payment account (such as a credit card or debit card account) to a consumer or cardholder. The issuer of a biometric payment card maintains the payment card accounts of its cardholders, including biometric payment card account holders.

In general, and for the purpose of introducing concepts of novel embodiments described herein, disclosed are methods, apparatus and systems that allow a consumer or user to securely and conveniently enroll his or her biometric data directly into a newly issued biometric payment card. It has been recognized that capturing and loading biometric data onto a biometric payment card is not as straight forward as loading biometric data onto a mobile device (such as a smartphone). For example, saving biometric data such as fingerprint template data onto the mobile device can be relatively straight forward, by following directions presented on a display screen of the mobile device while utilizing an integrated fingerprint sensor of the mobile device. Consumers, however, desire a convenient method for enrolling after receiving a newly issued biometric payment card, while issuer FIs desire an enrollment process that is inexpensive and includes obtaining robust consumer biometric data for use in authenticating the cardholder.

For ease of understanding, the example embodiments described herein include a biometric payment card having an integrated fingerprint sensor. The disclosed enrollment processes involve obtaining fingerprint template data from the customer or cardholder during a first or initial use of the biometric payment card involving a purchase transaction, and then utilizing that fingerprint template data in subsequent transactions. In some embodiments, under some circumstances and/or conditions, subsequent fingerprint data obtained from the cardholder during one or more subsequent purchase transactions may be used to modify and/or replace the stored fingerprint template data on the biometric payment card. However, it is contemplated that other types of biometric sensors could be integrated onto a biometric payment card instead of, or in addition to, a fingerprint sensor, such as a retina scanner or an audio sensor (such as a microphone) for obtaining biometric data from the consumer during an authentication process. Thus, although embodiments described herein relate to using fingerprint data obtained from the cardholder, the processes disclosed herein could also be utilized with other types of biometric data.

Accordingly, in some embodiments disclosed herein, an issuer financial institution (FI) sends a package containing a biometric payment card to the consumer who applied for (and qualified for) obtaining a biometric payment card account. The package contains the biometric payment card along with instructions for activating the basic payment card functions. In some embodiments, the cardholder activates the biometric payment card by, for example, calling a voice recognition unit (VRU) from a home telephone number (which the issuer FI has on file), or by calling a customer service representative, or by logging into the issuer FI's website or application to confirm receipt of the biometric payment card. In some implementations, the package also includes instructions for the cardholder to enroll biometric data into the biometric payment card during a first purchase transaction in order to activate the biometric technology features of the biometric payment card, which process is described in detail below. In addition, in some embodiments data stored in the biometric payment card is updated during a subsequent purchase transaction under some circumstances, for example, to improve the biometric data (such as fingerprint template data) stored on the biometric payment card. Thus, enrollment of biometric data by the cardholder occurs during a first use of the biometric payment card by the cardholder, and biometric data updates may also occur during subsequent usage under some circumstances, in accordance with procedures described herein during card usage in the field, when the genuine cardholder attempts to perform purchase transactions.

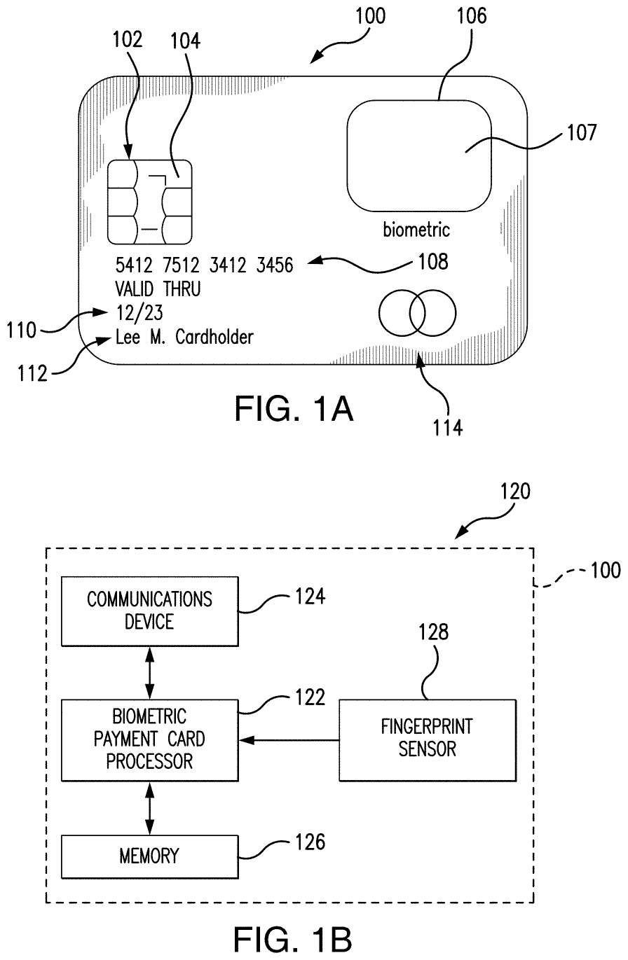

FIG. 1A is a diagram illustrating a biometric payment card 100 in accordance with some embodiments. The biometric payment card 100 may be transmitted to the consumer or user by his or her issuer FI via, for example, via the U.S. mail or by courier to the consumer's home or residence. In some embodiments, the biometric payment card 100 is a smart card or chip card that includes an EMV® chip 102 having a contact faceplate 104 on the front side or face of the card. The EMV® chip 102 may be a computer chip or computer processor with an operating system, one or more applications, and a data storage component or element (not shown) which stores instructions for conducting operations in accordance with processes described herein. The EMV® chip 102 permits the biometric payment card 100 to interact with a merchant card reader (not shown) in accordance with EMV® specifications to process purchase transactions. Specifically, the EMV® chip 102 operates in accordance with the EMV® contactless specifications which concern transactions using proximity near-field communications (NFC) payment devices. The NFC devices allow transactions to be made by waving or tapping the payment card containing the EMV° chip on an EMV° contactless enabled terminal, such as the payment card reader device 202. In embodiments disclosed herein, the EMV® chip 102 is operably connected to a biometric sensor 106, which in this example is an integrated or embedded fingerprint sensor 106 having a finger touch pad 107 on the front side surface or face of the biometric payment card 100.

In some embodiments, the biometric payment card 100 is made of a plastic material, and has dimensions conforming to the known ID-1 format, which is commonly used for credit cards, debit cards, ATM cards and the like. (The ID-1 format specifies a card size of 85.60×53.98 mm (3 ⅜ inches by 2 ⅛ inches), and includes rounded corners having a radius of between 2.88 millimeters (mm) to 3.48 mm). The biometric payment card 100 may also include a primary account number (PAN) 108, an expiration date 110, the cardholder's name 112, and a payment card logo 114 which are printed or embossed on the front side or face of the payment card 100. It should be understood that the biometric payment card 100 may be made of other types of materials (i.e., a metallic material or composite material), and may include other features and/or components.

FIG. 1B is a block diagram 120 of the components of a biometric payment card in accordance with some embodiments. In some embodiments, the biometric payment card 100 includes a biometric payment card processor 122 operably connected to a communications device 124 and to a memory 126. A fingerprint sensor is also operably connected to the biometric payment card processor 122 and is operable to provide fingerprint data obtained from a cardholder to the biometric payment card processor 122. In implementations disclosed herein, the communications device 124 is a near-field communication (NFC) device operable to communicate with, for example, an NFC reader device of a merchant and the like. The memory 126 may store an operating system, one or more applications, and instructions for conducting operations, such as a cardholder enrollment process and a fingerprint template data update process, in accordance with processes described herein. In some embodiments, the biometric payment card processor 122 is an EMV® chip which operates as explained above in accordance with EMV® specifications to process purchase transactions.

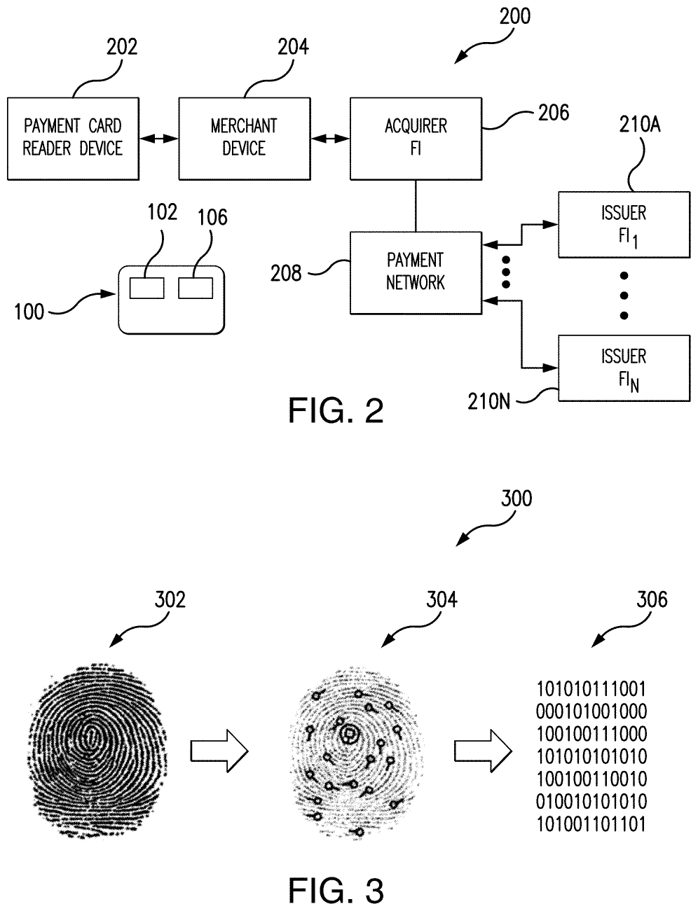

FIG. 2 is a block diagram of a purchase transaction system 200 to illustrate a biometric authentication method and a cardholder fingerprint enrollment process in accordance with some embodiments. During a purchase transaction, in some implementations the biometric authentication process entails a cardholder presenting his or her biometric payment card 100 to a chip-enabled NFC payment card reader 202 while at the same time holding his or her thumb on the finger touch pad 107 of the built-in fingerprint sensor 106 located on the face of the biometric payment card. Fingerprint template data is then extracted from the cardholder's fingerprint image (thumb print) received from the fingerprint sensor 106 and compared against one or more cardholder fingerprint template(s) stored in a memory of the biometric payment card 100. The card reader 202 then receives data indicating whether the biometric authentication of the cardholder was successful or failed (e.g., whether fingerprint template data of the user matches one or more stored biometric templates) along with cardholder identification data. In addition, in some implementations a matching score may also be generated by the EMV® chip and transmitted to the payment card reader device 202. In implementations described herein, the payment card reader device 202 transmits the biometric authentication data, the cardholder identification information and the matching score to the merchant device 204 (which may be a point of sale device, such as a cash register) for further processing.

In accordance with embodiments described herein, a user or cardholder of a newly issued biometric payment card 100 enrolls his or her fingerprint template data during a first purchase transaction with the biometric payment card. For example, referring to FIGS. 1A, 1B and 2, after bringing items to purchase to a cashier in a merchant's retail store, the consumer takes out her biometric payment card and places her right forefinger on the finger touch pad 107 of the biometric sensor 106, then orients the payment card so that the EMV® chip 102 can be inserted into a slot (not shown) in the payment card reader device 202 (or orients the EMV® chip 102 so that the payment card 100 can be tapped on a landing pad of the payment card reader device 202, which is not shown). The cardholder inserts the biometric payment card 100 and EMV chip 102 into the slot (or taps it on the landing pad), and since this is the first time that the biometric payment card 100 is being used, fingerprint template data is not available (no such data is yet stored within the biometric payment card 100) for use to authenticate the cardholder. Thus, a biometric authentication process, or fingerprint matching process, will fail due to the non-availability of any stored fingerprint template(s) data. In this situation, the payment card reader device 202 will fall back on a cardholder verification method (CVM) process requiring the cardholder to enter a personal identification number (PIN) or the like. Accordingly, in some implementations the payment card reader 202 prompts the cardholder (for example, by displaying a message on a display screen, not shown) to enter her four-digit PIN using a numeric touch pad (not shown) associated with the payment card reader device. Next, after the PIN is entered, the purchase transaction data (which may include the cardholder's PIN and cardholder account information) is transmitted by the payment card reader device 202 to the merchant device 204 and ultimately to the issuer financial institution (FI) 210A which issued the biometric payment card for purchase transaction authorization processing.

In the scenario described immediately above, in accordance with embodiments disclosed herein, the issuer FI performs a purchase transaction authorization procedure based on the PIN provided by cardholder and its' own internal fraud and/or analytics processing, to confirm it's a genuine transaction and that the PIN matches stored data associated with the cardholder. The issuer FI also determines whether the cardholder has adequate funds or an adequate credit line to cover the cost of the purchase transaction. When the purchase transaction is authorized, the issuer FI transmits an authorization message to the merchant device 204 via the payment network 208 and acquirer FI 206 along with an additional enrollment message. The enrollment message is transmitted to the payment card reader device 202 and forwarded to the biometric payment card 100, and includes instructions for the EMV® chip 102 to store the fingerprint template data presented earlier by the cardholder (when the cardholder first presented the biometric payment card 100 to the payment card reader device 202 to conduct the transaction) as enrollment biometric data (enrollment fingerprint template data). This enrollment fingerprint template data will then be used when the cardholder next utilizes her biometric payment card 100 for another or subsequent purchase transaction.

Thus, after the enrollment process occurs, during a subsequent purchase transaction, the consumer takes out her biometric payment card 100 and again places her right forefinger on the finger touch pad 107 of the biometric sensor 106 and taps the biometric payment card on a landing pad of the payment card reader device 202. In this case, since there is a fingerprint template stored within the biometric payment card, then a biometric matching process is conducted which compares the fingerprint template data extracted from the cardholder's right finger image data to the stored fingerprint template data. If a match occurs, then the cardholder is authenticated and purchase transaction information along with cardholder information is transmitted via the merchant acquirer financial institution (FI) 206 to the payment network 208. The payment network 208 then determines which one of a plurality of issuer FIs (210A to 210N) issued the cardholder's biometric payment card, and then transmits the biometric authentication data and purchase transaction data to that issuer FI 210A. The issuer FI 210A then determines, based on the cardholder authentication data and on the creditworthiness of the cardholder, to authorize or to decline the purchase transaction. Thus, the issuer FI 210A generates and transmits an authorization or decline message back to the merchant device 204 via the payment network 208 and acquirer FI 206.

In some implementations, if the biometric authentication failed (e.g., the current fingerprint template data of the cardholder did not match the enrollment fingerprint template data) then the card reader 202 may prompt the cardholder to try again (for example, by displaying a message on a display screen). If the cardholder again cannot match his or her fingerprint to the stored fingerprint template data, then the cardholder may be asked to enter an alternate cardholder verification method (CVM) such as a personal identification number (PIN), which the merchant then handles in accordance with the merchant's purchase transaction risk procedures. As explained above, such a purchase transaction process assumes that the cardholder has already enrolled his or her biometric data (for example, fingerprint template data) into the biometric payment card 100.

FIG. 3 is a graphical flow diagram 300 illustrating enrollment of a digital image of a cardholder's fingerprint according to some embodiments. Biometric data recognition systems and processes may include the use of a sensor, a feature extraction process, a database, and after storing a biometric template, a matching process. Thus, with reference to FIGS. 1 and 3, the fingerprint sensor 106 of the biometric payment card 100 acquires a digital image 302 of the cardholder's fingerprint during use of the biometric payment card, and then identifies and extracts distinguishing features 304 of the fingerprint. The distinguishing features 304 are then translated into digital fingerprint template data 306. In embodiments disclosed herein, during the first use of the biometric payment card 100 and after the cardholder has been authenticated by the issuer FI using an alternate type of cardholder verification method (CVM), the digital fingerprint template data 306 is stored as biometric enrollment data for use in a biometric authentication process in a subsequent purchase transaction. Stated another way, after enrollment, in a subsequent purchase transaction the stored digital fingerprint template data 306 is utilized to authenticate the cardholder of the biometric payment card 100.

Accordingly, after enrollment, the consumer can utilize the fingerprint feature of her biometric payment card 100 to perform purchase transactions. For example, the cardholder can dip or tap the biometric payment card at a merchant's chip-enabled terminal while at the same time holding his finger (such as his thumb) on the face 107 of the integrated fingerprint sensor 106. A processor embedded in the EMV® chip 102 of the biometric payment card compares the extracted features of the user's fingerprint image (picked up by the fingerprint sensor 106) to the fingerprint template data 306 stored on the card. In some embodiments, a match occurs when a matching score generated by the EMV® chip 102 is above a matching threshold value. In some embodiments, the matching score relates to how closely the current fingerprint template data matches the stored fingerprint template data (which may be the enrollment fingerprint template data) based on a percentage match, and the threshold value is set or predetermined by the issuer FI (the issuer of the cardholder's biometric card account). For example, if the matching threshold is set at sixty percent (60%) by the issuer FI and the matching score is ninety percent (90%), this means that ninety percent of the fingerprint features of the stored fingerprint template data matched the cardholder's current fingerprint data obtained by the fingerprint sensor 106 of the biometric payment card 100. Accordingly, the cardholder is authenticated. When such a match occurs, in some implementations the biometric payment card 100 transmits an indication of successful cardholder authentication along with payment card account credentials and additional information concerning the match (such as matching score) to the merchant's chip reader device 202, which forwards the information to an acquirer FI 206 for further processing (see FIG. 2; wherein such processing involves a payment card network 208 and the issuer FI 210N that issued the biometric payment card, as explained above). In some embodiments, details of the match, such as the matching score, may be transmitted in a predefined field (such as the DE48/DE55 field) of the purchase transaction data to the issuer FI for further processing.

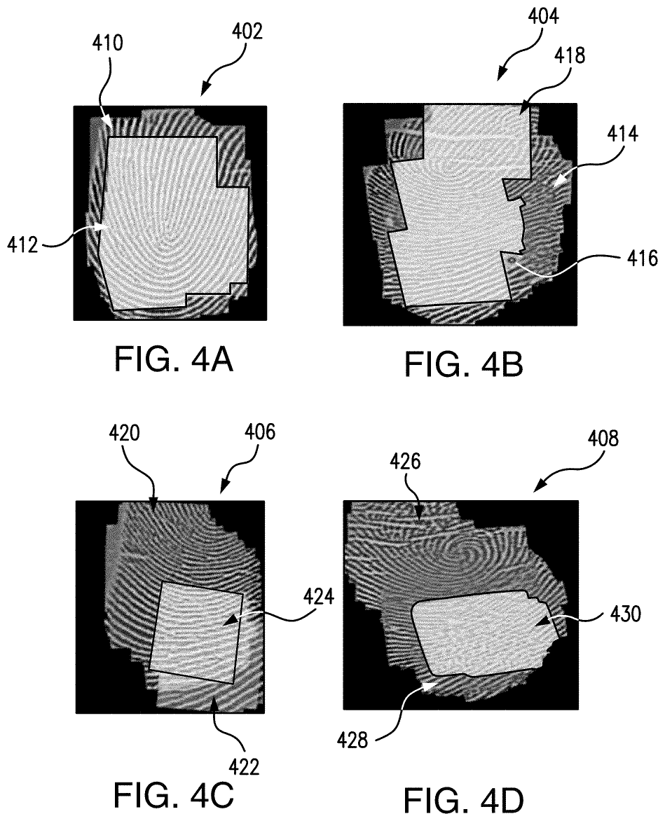

In some embodiments, when the issuer FI receives the matching score from the merchant system, then the issuer FI's backend system determines whether to conduct further processing. FIGS. 4A through 4D illustrate examples of cardholder fingerprint matching behaviors 402, 404, 406 and 408 in accordance with some embodiments. FIGS. 4A and 4B show a first example 402 and a second example 404 of very good and thus highly acceptable overlap of cardholder fingerprint features between an enrollment area and a verification area.

In FIG. 4A, the first example 402 illustrates a verification area 410 which covers substantially all of the enrollment area, and thus an overlap area 412 of the fingerprint features is provided that has a matching score of close to one hundred percent (indicating high overlap of fingerprint features). Similarly, in FIG. 4B, the second example 404 illustrates a verification area 414 which covers 95% of the enrollment area 416 resulting in an overlap area 418 having a matching score of about 95%. Thus, if the issuer FI's matching threshold is 60% then matching scores of substantially 100% and about 95% both indicate a very good match (high overlap of fingerprint features), and the issuer FI's backend system may determine that, in the most probable scenario for both cases, the consumer has presented the same area of her finger to the fingerprint sensor 106 of her biometric payment card 100 as provided during enrollment. In such a scenario, the cardholder is authenticated and the issuer FI realizes or recognizes that updating the stored biometric data (the stored fingerprint template data) will not fetch or provide any additional features of the user's fingerprint. Thus, the Issuer FI's backend system may respond by authorizing the purchase transaction without providing any instructions to update the fingerprint template(s) (or fingerprint template data) stored in the biometric payment card.

However, FIGS. 4C and 4D show a third example 406 and a fourth example 408, respectfully, of barely satisfactory or poor overlap of cardholder fingerprint features between an enrollment area and a verification area. In FIG. 4C, the third example 406 illustrates a verification area 420 which only covers about 65% of the enrollment area 422 resulting in an overlap area 424 having a matching score of about 65%. Similarly, the fourth example 408 of FIG. 4D illustrates a verification area 426 which covers only about 70% of the enrollment area 428 and thus provides an overlap area 430 of the fingerprint features having a matching score of about 70%. Thus, if the issuer FI's matching threshold is 60% as discussed above, then matching scores of about 65% and about 70% both indicate barely acceptable matches, and the issuer FI's backend system may determine that the most probable scenario is that the consumer presented a different area of her finger to the fingerprint sensor 106 on the biometric payment card 100. In such cases, updating the cardholder's fingerprint template data could provide some additional features of the cardholder's fingerprint. Consequently, in such scenarios, the issuer FI's backend system responds with an authorization message which authorizes the purchase transaction, and which includes instructions for the EMV® chip 102 (or the biometric payment card processor) to update the cardholder's fingerprint template data with the current acquired digital fingerprint data. In some implementations, updating includes replacing the enrolled fingerprint template data with the current cardholder's fingerprint template data.

In some embodiments, a consumer is required to enroll by placing one of her thumbs on the biometric sensor when making a first purchase transaction. Thus, a fingerprint template for only one thumb, for example the right thumb, of the consumer is stored on the card. However, in some implementations a consumer may be required to enroll by providing two or more fingerprints so that fingerprint template data can be stored corresponding to, for example, an index finger and a thumb. Such fingerprint data may also be stored on the biometric payment card as separate digital fingerprint templates. The number of fingers and/or fingerprint template data for storing on the payment card may be configurable and/or predefined, for example, by the issuer FI of the biometric payment card. In addition, the number or amount of fingerprint templates can vary depending on criteria required by the issuer of the biometric payment card and/or on physical constraints, such as the available storage space available on the biometric payment card.

In the case where the biometric authentication failed (there was no match between the fingerprint template data stored on the biometric payment card and the fingerprint data provided by the cardholder), then the merchant's card reader may display a request for the cardholder to try again. If biometric authentication continues to fail after one or more additional attempts, then the cardholder may be asked to enter an alternate cardholder verification method (such as a PIN or signature), which the merchant then handles in a manner according to that merchant's purchase transaction risk procedures.

In some embodiments, the issuer FI can utilize the matching score information to manage and/or to better control the cardholder authentication and/or the purchase transaction authorization process. In particular, the issuer FI backend system may have additional flexibility to utilize the matching score data with additional data or criteria concerning or associated with the cardholder to modify and/or to adjust the cardholder authentication parameters or criteria and/or the purchase transaction authorization parameters or criteria. For example, if the cardholder is utilizing her biometric payment card in a country, such as Singapore, that has tropical weather (high humidity), then the issuer FI backend system may adjust the matching threshold downwards because such locations with high humidity may detrimentally affect the matching score as compared to a drier location, such as New York City. Thus, for Singapore the matching threshold may be lowered to 52%, whereas for New York City the matching threshold may be increased to 75% for most purchase transactions. In another example, if a particular cardholder typically exhibits a high matching score such as 90%, but now is exhibiting a matching score close to the matching threshold of 65%, such behavior may be an indication of fraud. In addition, some user behaviors can provide information and/or data that may indicate that the issuer FI needs to train and/or coach the cardholder concerning how to best utilize the biometric payment card.

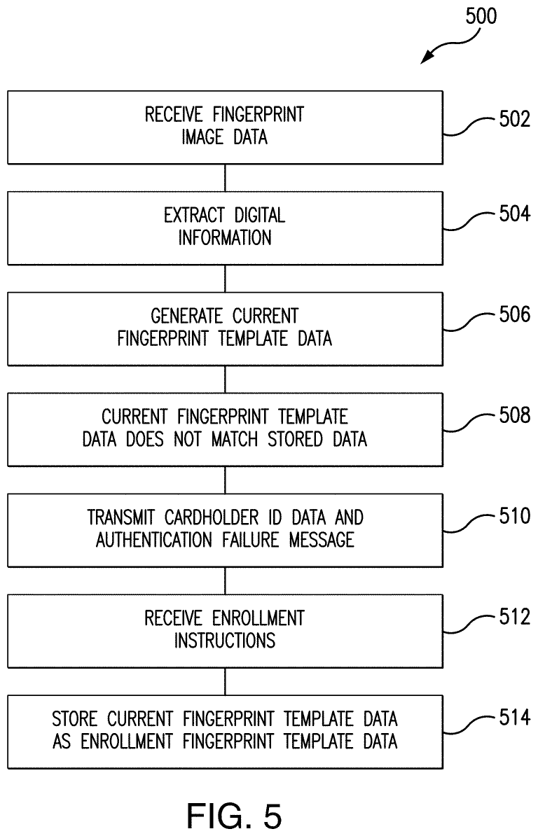

FIG. 5 is a flowchart of a biometric payment card enrollment process 400 in accordance with some embodiments. In some embodiments, the consumer first activates his or her biometric payment card by, for example, calling a voice recognition unit (VRU) of the issuer FI from a home telephone number, or by logging in to the issuer's website or application to confirm receipt of the biometric enrollment package containing the biometric payment card. Then, when the cardholder wishes to conduct her first or initial purchase transaction, she places her thumb on the fingerprint sensor and presents her biometric payment card to a card reader. The biometric payment card processor of the biometric payment card receives 502 fingerprint image data of the cardholder's finger from the fingerprint sensor, extracts 504 digital information from the fingerprint image data, and generates 506 current fingerprint template data from the extracted digital information. The the biometric payment card processor then compares the current fingerprint template data to data stored in a memory and determines 508, since this is the initial or first purchase transaction, that the current fingerprint template data does not match any data stored in the memory. Next, the biometric payment card processor transmits 510 cardholder identification data and an authentication failure message (which indicates failure of the matching process, or the biometric cardholder authentication process) to the payment card reader device. Next, the biometric payment card processor receives 512 enrollment instructions from the payment card reader device and stores 514 the current fingerprint template data as enrollment fingerprint template data in the memory, and the process ends. It should be understood that, in the process described immediately above, the issuer FI recognizes that the current purchase transaction is the initial or first purchase transaction attempted by the cardholder, and thus provides the instructions which are ultimately received by the biometric payment card processor via the payment card reader device to store the current fingerprint template data as the enrollment fingerprint template data for use in subsequent purchase transactions.

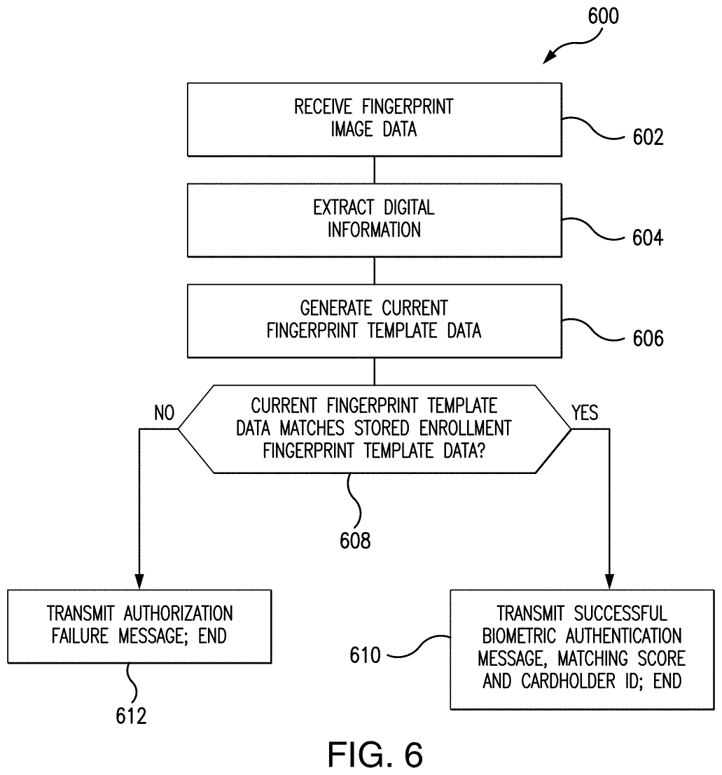

FIG. 6 is a flowchart of a biometric payment card updating process 600 in accordance with some embodiments. When the cardholder wishes to conduct subsequent purchase transactions (after the initial purchase transaction), she places her thumb on the fingerprint sensor and presents her biometric payment card to a card reader. The biometric payment card processor of the biometric payment card receives 602 fingerprint image data of the cardholder's finger from the fingerprint sensor, extracts 604 digital information from the fingerprint image data, and generates 606 current fingerprint template data from the extracted digital information. Next, the biometric payment card processor compares 608 the current cardholder fingerprint template data to the enrollment fingerprint template data stored in a memory, and when the current fingerprint image template matches the enrollment fingerprint template transmits 610 a message indicating successful biometric cardholder authentication processing, a matching score, and cardholder identification data to the payment card reader device, and the process ends. However, if it is determined in step 608 that the current fingerprint image template does not match the enrollment fingerprint template, then the biometric payment card processor transmits 612 an authentication failure message indicating unsuccessful biometric cardholder authentication processing to the payment card reader device and the process ends.

Systems, apparatus and processes disclosed herein advantageously provide consumers or cardholders with a convenient and secure method for enrolling biometric data into a newly issued biometric payment card. In addition, the disclosed systems, apparatus and processes for consumer enrollment into a biometric payment card are inexpensive for issuer FIs to deploy. Furthermore, methods described herein advantageously permit issuer FIs the flexibility to change the biometric cardholder authentication parameters and/or requirements for one or more biometric card holders based on various criteria or circumstances. For example, a matching threshold and/or a matching score for a particular cardholder or group of cardholders may be increased or decreased depending on conditions or criteria such at the weather near the cardholders' residence or retail store locations or based on cardholder or user behavior(s). In addition, the behavior of a biometric payment card cardholder may indicate that the issuer FI needs to provide training or coaching concerning the correct usage of the biometric payment card.

As used herein and in the appended claims, the term “computer” should be understood to encompass a single computer or two or more computers in communication with each other. In addition, as used herein and in the appended claims, a “server” includes a computer device or system that responds to numerous requests for service from other devices.

Also, as used herein and in the appended claims, the term “processor” should be understood to encompass a single processor or two or more processors in communication with each other. In addition, as used herein and in the appended claims, the term “memory” should be understood to encompass a single memory or storage device or two or more memories or storage devices.

The flow charts and descriptions thereof herein should not be understood to prescribe a fixed order of performing the method steps described therein. Rather the method steps may be performed in any order that is practicable, including simultaneous performance of steps, and/or in an order that omits one or more steps.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method for enrolling a biometric payment card comprising:
receiving, by a biometric payment card processor from a fingerprint sensor during an initial purchase transaction, fingerprint image data of a cardholder's finger;
extracting, by the biometric payment card processor, digital information from the fingerprint image data;
generating, by the biometric payment card processor, current fingerprint template data from the extracted digital information;
comparing, by the biometric payment card processor, the current fingerprint template data to data stored in a memory;
determining, by the biometric payment card processor, that the current fingerprint template data did not match any data stored in the memory;
transmitting, by the biometric payment card to a payment card reader device, cardholder identification data and an authentication failure message indicating failure of a biometric cardholder authentication process;
receiving, by the biometric payment card processor from the payment card reader device, enrollment instructions; and
storing, by the biometric payment card in the memory responsive to the enrollment instructions, the current fingerprint template data as enrollment fingerprint template data.

2. The method of claim 1, further comprising, prior to receiving the fingerprint image data of a cardholder's finger during the initial purchase transaction, activating a biometric payment card account associated with the biometric payment card for conducting purchase transactions.

3. The method of claim 2, wherein activating the biometric payment card account comprises informing the issuer financial institution (FI) of receipt of the biometric payment card by at least one of calling a voice recognition unit (VRU) from a telephone number which the issuer FI has on file, calling a customer service representative of the issuer FI, or logging into the issuer FI's website.

4. The method of claim 1, further comprising:
receiving, by a biometric payment card processor from the fingerprint sensor during a subsequent purchase transaction, subsequent fingerprint image data of a cardholder's finger;
extracting, by the biometric payment card processor, digital information from the subsequent fingerprint image data;
generating, by the biometric payment card processor, a current cardholder fingerprint image template from the extracted digital information;
comparing, by the biometric payment card processor, the current cardholder fingerprint image template to the enrollment fingerprint template data stored in a memory;
determining, by the biometric payment card processor, that the current fingerprint image template matches the enrollment fingerprint template data;
transmitting, by the biometric payment card to the payment card reader device, a message indicating successful biometric cardholder authentication processing, a matching score, and cardholder identification data.

5. The method of claim 4, wherein the matching score is based on a percentage match of the current cardholder fingerprint image template to the enrollment fingerprint template data.

6. The method of claim 4, wherein determining that the current fingerprint image template matches the enrollment fingerprint template data comprises:
comparing, by the biometric payment card processor, the current fingerprint image template to the stored enrollment fingerprint template data;
generating, by the biometric payment card processor, a matching score based on the percentage match of the current fingerprint image template to the stored enrollment fingerprint template data; and
determining, by the biometric payment card processor, that the matching score is greater than a threshold value.

7. The method of claim 6, wherein the threshold value is set by the cardholder's issuer financial institution.

8. The method of claim 4, wherein the matching score is indicative of a barely acceptable match, and further comprising:
receiving, by the biometric payment card processor from the payment card reader device, instructions to update the stored enrollment fingerprint template data; and
replacing, by the biometric payment card processor, the enrollment fingerprint template data with the current fingerprint image template data for use in authenticating the cardholder during subsequent purchase transactions.

9. The method of claim 4, wherein the matching score is indicative of a barely acceptable match, and further comprising:
receiving, by the biometric payment card processor from the payment card reader device, instructions to update the stored threshold value; and
updating, by the biometric payment card processor the stored threshold value.

10. A biometric payment card comprising:
a biometric payment card processor;
a memory operably connected to the biometric payment card processor;
a communications device operably connected to the biometric payment card processor; and
a fingerprint sensor operably connected to the biometric payment card processor;
wherein the memory stores executable instructions when executed cause the biometric payment card processor to:
receive, during an initial purchase transaction from the fingerprint sensor, fingerprint image data of a cardholder's finger;
extract digital information from the fingerprint image data;
generate current fingerprint template data from the extracted digital information;
compare the current fingerprint template data to data stored in the memory;
determine that the current fingerprint template data did not match any data stored in the memory;
transmit cardholder identification data and an authentication failure message indicating failure of a biometric cardholder authentication process to a payment card reader device;
receive enrollment instructions from the payment card reader device; and
store, in response to the enrollment instructions, the current fingerprint template data as enrollment fingerprint template data in the memory.

11. The biometric payment card of claim 10, wherein the memory stores further executable instructions that when executed cause the biometric payment card processor to:
receive from the fingerprint sensor during a subsequent purchase transaction, subsequent fingerprint image data of a cardholder's finger;
extract digital information from the subsequent fingerprint image data;
generate a current cardholder fingerprint image template from the extracted digital information;
compare the current cardholder fingerprint image template to the enrollment fingerprint template data stored in a memory;
determine that the current fingerprint image template matches the enrollment fingerprint template data; and
transmit a message to the payment card reader device indicating successful biometric cardholder authentication processing, a matching score, and cardholder identification data.

12. The biometric payment card of claim 11, wherein the matching score is based on a percentage match of the current cardholder fingerprint image template to the enrollment fingerprint template data.

13. The biometric payment card of claim 10, wherein the instructions for determining that the current fingerprint image template matches the enrollment fingerprint template data comprise executable instructions that when executed cause the biometric payment card processor to:
compare the current fingerprint image template to the stored enrollment fingerprint template data;
generate a matching score based on the percentage match of the current fingerprint image template to the stored enrollment fingerprint template data; and
determine that the matching score is greater than a threshold value.

14. The biometric payment card of claim 13, wherein the threshold value is set by the cardholder's issuer financial institution.

15. The biometric payment card of claim 13, wherein the matching score is indicative of a barely acceptable match and the memory stores further executable instructions that when executed cause the biometric payment card processor to:
receive instructions from the payment card reader device to update the stored enrollment fingerprint template data; and
replace the enrollment fingerprint template data with the current fingerprint image template data for use in authenticating the cardholder during subsequent purchase transactions.

16. The biometric payment card of claim 13, wherein the matching score is indicative of a barely acceptable match and the memory stores further executable instructions that when executed cause the biometric payment card processor to:
receive instructions from the payment card reader device, to update the stored threshold value; and
update the stored threshold value.
